(19) United States
(12) Patent Application Publication
(10) Pub. No.: US 2017/0203314 A1
(43) Pub. Date: Jul. 20, 2017

(54) Two Component Airless Adhesive Spray Gun and Method of Use

(71) Applicant: Robert J. Rose, Richmond, VA (US)

(72) Inventor: Robert J. Rose, Richmond, VA (US)

(21) Appl. No.: 15/409,649

(22) Filed: Jan. 19, 2017

Related U.S. Application Data
(60) Provisional application No. 62/280,384, filed on Jan. 19, 2016.

(51) Int. Cl. B05B 7/08; B05B 12/00; B05B 7/12

(52) U.S. Cl. CPC B05B 7/0846; B05B 7/12; B05B 12/002; B05B 7/2472

(57) ABSTRACT

A two part airless adhesive spray system is provided herein. This system provides numerous enhancements to the prior art including limiting overspray “fog,” saving on sprayed material because of a more efficient spray pattern, and providing a stronger bond than that of the air-atomized spray guns of the prior art.

### BACKGROUND

When applying water based adhesives by hand spray techniques or automated/machine controlled spray techniques, such as for the furniture and bedding industries, there is a problem with adhesive overspray. The overspray presents itself as a fog in the factory that can carry long distances from the actual application area of the factory. This fog also creates a nuisance dust health hazard for the employees. Lastly, the fog or overspray is wasteful of resources as the adhesive is lost and not used for its intended purpose. This overspray not only gets onto the employees that apply the adhesive, but also contaminates nearby equipment, finished product, or raw materials in inventory, and contaminates air conditioners, heaters, and lighting.

One solution has been to set up air extraction hoods in the spray area. This works relatively well when the filters are maintained and the types of parts that are being assembled are small. However when making larger items such as mattresses, large sofa cushions, and the like, the usefulness of an air extraction hoods is negated because of the impracticality of extraction hoods that are sized for large items.

Also, there have been attempts to control the overspray fog by using low fogging air atomized guns such as the DUX or EasyFlow Laminair spray gun. Although these spray devices minimize the overspray when adjusted properly, they are dependent on the spray operators not adjusting the settings because they can easily be misadjusted and create fog.

Another solution has been to use different types of adhesive bases other than water base. Solvent based adhesives and hot melt adhesives do not create a fog when sprayed. These types of adhesives work well to eliminate the overspray, but have other problems.

Solvent based adhesives contain hazardous materials and are often flammable. They require air extraction equipment to reduce the flammability hazard as well as the health hazards to employees. Also, solvent adhesives do not adhere some types of visco-elastic foams.

Hot melt adhesives typically do not bond foam cushion substrates as well as water based or solvent based products. Hot melts also require melt tanks and heated hose, and this equipment is more expensive on a per gun basis than water based or solvent adhesives.

Another solution is the roll coating of water based adhesive rather than spray application. Roll coating eliminates the over spray, but suffers additional problems because the rollers are exposed to the atmosphere. As such, during any down time at all, the adhesive on the rollers can coagulate, causing inconsistent application of the adhesive. In addition, at the end of a shift, the workers must clean the rollers, adding to the system downtime and taking away working time from the workers. Further still, rollers do not allow a control of the application rate over a surface. Although roll coating provides a consistent application of adhesive across an entire surface, sometimes it is advantageous to vary the application rate of the adhesive. For example, it may be advantageous to use more adhesive in one area, and less in another, thereby using less adhesive overall.

### SUMMARY

The subject matter of this application may involve, in some cases, interrelated products, alternative solutions to a particular problem, and/or a plurality of different uses of a single system or article.

In one aspect, a two component adhesive spray gun system is provided. The spray gun may be airless in most embodiments, but in some cases may include an air atomizing aspect. The system comprises a spray gun, an adhesive source connected to the gun, and an activator source connected to the gun. The spray gun may comprise a handle body, with a trigger attached to the handle. The trigger solely controls both a position of a first actuating needle, and a second actuating needle simultaneously by mechanical connection to both. The first and second needle positioning is achieved without control or assistance from any other structure or mechanism such as, for example, an air assist control of the needles, hydraulic control, and the like. Each of these needles is connected to the trigger and is movable between a closed position and an open position using only movement caused by the trigger. Both needles, and in turn the trigger, are biased in the closed position. The spray gun also has an adhesive inlet port and activator inlet port in separate spray chambers allowing connection between the adhesive source and activator source, respectively, to the spray gun. An adhesive nozzle for spraying of the adhesive may include an interior portion and an outer nozzle. Similarly, an activator nozzle for spraying the adhesive activator may include an interior portion and outer nozzle. In one embodiment, the trigger of the present invention may be a single trigger that is forked into two trigger side portions, forming a ‘Y’ shape. Each of the two side portions is connected to one of the first or second actuating needle. Upon a pulling of the trigger, each actuating needle is also pulled physically by the trigger side portions, which allows fluid flow through each of the adhesive and activator chambers and nozzles to spray both components.

### BRIEF DESCRIPTION OF THE FIGURES

FIG. 1 provides a side view of an embodiment of the present invention.

FIG. 2 provides an exploded view of another embodiment of the present invention.

FIG. 3 provides a perspective view of an embodiment of the spray gun of the present invention.

FIG. 4 provides a perspective view of an embodiment of the spray gun of the present invention.

FIG. 5 provides a top view of still another embodiment of the present invention.

FIG. 6 provides a view of an embodiment of the forked trigger of the present invention.

FIG. 7 provides an exploded view of yet another embodiment of the present invention.

FIG. 8 provides a detail view of a trigger of the present invention.

FIG. 9 provides a perspective view of still yet another embodiment of the present invention.

### DETAILED DESCRIPTION

The present invention concerns a two component (“part”) adhesive spray system that utilizes entirely mechanical structures to open and close a nozzle for each of the two components. In most embodiments, pressure through nozzles of the two components achieves the atomized spraying of the components.

In a two part airless adhesive spray embodiment, contemplated herein, the range of adhesive formulations that will work may be any water based adhesive that is stable enough to be airlessly sprayed. Particularly, any water based adhesive such as polychloroprene latex, or other lattices such as styrene butadiene rubber (SBR), Acrylic, Vinyl Acetate Ethylene(VAE), Poly-Vinyl Acetate (PVA), Vinyl Acrylic, Nitrile, Styrene Acrylic, Polyisoprene, Butyl Rubber, Guayule, and Natural Rubber that has a low viscosity can be sprayed using the two part airless system.

In one embodiment, the present two part airless system consists of an airless spray gun that sprays adhesive through an atomizing nozzle without air assisted atomization through a first spray head. A separate spray head airlessly sprays an activator simultaneously through a second atomizing nozzle to mix with the water based adhesive after both are atomized and sprayed, giving the mixture instant tack or holding power to a surface on which it is sprayed.

Generally it is the case for sprayed adhesives that the better an adhesive works to adhere, the worse it performs in a sprayed application. This is because the application of pressure, and the shear forces caused by forcing the adhesive through piping, spray gun internal flow paths, and a spray nozzle all cause the adhesive to coagulate and start acting as an adhesive as opposed to a fluid. The air atomized spray guns used in the prior art seek to limit the forces on the adhesive by using air atomization. An airless spray gun/system only magnifies the problems faced above: Airless spray guns and systems use higher pressure, have faster moving fluid (causing higher shear forces), and force the adhesive through a very small hole to cause it to atomize without the use of an air curtain or air stream. As such, airless spray guns are not considered to be an option in this field. The present invention unexpectedly overcomes these issues, using an airless spray gun to achieve airless spraying without the downfalls that would be expected, and further, resulting in a process that overcomes the issues of air atomized spray guns, namely overspray. Moreover, the effectiveness of the airless spray is enhanced by the use of an activator sprayed from a second nozzle.

The atomization of the adhesive and activator is caused when the fluids are expelled through an airless gun tip that atomizes and spreads the fluids into a controlled spray pattern. This is in contrast to an air atomized spray gun which atomizes the adhesive using an air stream or air curtain. The airless spray gun and adhesive or activator sprayed through their respective nozzles eliminates the problem of overspray fog seen in the prior art. Additionally, because no air connection is required, the spray gun of the present invention requires only pressurized fluid sources, and thus is much more portable and easier to use than the spray guns of the prior art.

In particular it has been observed that the present invention saves 30-40% compared to air atomized spray guns, in large part because of the elimination of the overspray discussed above. While typical airless spray guns operate using pressures of at least 300 psi. In some embodiments, the spray gun contemplated herein may achieve airless spray at less than 150 psi. In a particular embodiment, the present invention achieves airless spray at approximately 30-60 psi. It has also been observed that bonding is faster and stronger with the present airless spray gun adhesive application than in the air atomized spray gun prior art. This may be because of larger droplets in the airless spray gun system, which penetrate further into the material to be bonded, giving a stronger bond at a lower adhesive application rate.

The adhesives used in the present spray system are mechanically stable enough to withstand the mechanical shear forces encountered with airless spraying. When mixed with the activator, the adhesive provides instant grab or tack. Depending on adhesive selected, and spraying surface chosen, the activator becomes more essential. For example, when spraying highly porous surfaces, the activator becomes more vital because adhesion is more difficult. However, it should be understood that this adhesive spray system may be used for many other product manufacturing processes including lamination adhesion processes, among others.

Prior art two part spray guns use air to atomize and mix the components outside of the spray nozzle. They either introduce the activator into an air cap, mixing the activator and air, and subsequently activator and adhesive spray after it is sprayed from the gun as controlled by the air/activator mixture coming from the air cap; or, a stream of atomized activator can be introduced into the air atomized adhesive stream after the air cap. Both of these methods cause the adhesive and activator to be over-sprayed or cause a fog that carries into the plant as described above. The current invention does not require air to atomize or mix the two components. The atomization is achieved using airless spray tips which are designed to work with very low pressure.

The present two part airless system eliminates the problem of over spray by not using air to atomize either the adhesive or the activator. Further, the present two part airless system does not require any air pressure actuation to open and close the nozzles to allow spray there through because control of both nozzles is achieved by mechanical motion of a needle controlling flow through each of the adhesive and activator nozzles. These needles are mechanically controlled simultaneously by the single trigger. As such, the present invention is highly portable, maneuverable, and convenient to use because it does not need to be connected in any way to a pressurized air source.

Introduction of the activator into the adhesive is achieved by the specially designed angle of the spray heads which enables the adhesive and activator to meet after atomization through nozzles at a predetermined distance from the nozzle, thus allowing mixing while eliminating the adhesive overspray fog. In one embodiment, the mixing of the adhesive and activator may be in the air before reaching the surface to be sprayed. In another embodiment, the mixing of adhesive and activator may be on the surface being sprayed.

In varying embodiments, the ratio of adhesive to activator may be approximately 25:1 and more preferably approximately 10:1 with the best results at approximately 5:1. However, the invention will work with a ratio range of 1:2 to 25:1 (adhesive to activator). The various ratios may be achieved entirely by nozzle orifice sizes and fluid pressure variations.

In one embodiment, the adhesive selected and intended for use in the present invention is a water based dispersion with no co-solvents. The particular water based adhesives selected should be, in most embodiments, resilient enough to maintain flow properties under the shear forces of the spraying. Further, the water based dispersion adhesives selected and used herein in the airless spray gun may have a low viscosity and may be somewhat more stable to shear forces than other formulations known in the art. However, in one embodiment, the adhesive used herein may have enough instability to cause the emulsion to break quickly after spraying under the shear forces from the nozzle of the spray gun. This breaking may allow the adhesive to be able to adhere quickly and hold strongly enough for its applications. Such features are enhanced and/or made possible by mixing with the activator. In one embodiment, the adhesive may be used in foam fabrication such as that used in the furniture and bedding industries.

In a particular embodiment, the adhesive may be selected to be a polychloroprene latex base that can have other lattices such as styrene butadiene rubber (SBR), Acrylic, Vinyl Acetate Ethylene (VAE), Poly-Vinyl Acetate (PVA), Vinyl Acrylic, Nitrile, Styrene Acrylic, Polyisoprene, Butyl Rubber, Guayule, Natural rubber and the like added as well. A pH of the adhesive is lowered using Glycine, or other acid such as glycolic, lactic, citric, ascorbic, boric, and the like. Stabilizers are further added. The stabilizers may be any of: anionic soaps, nonionic surfactants, polymeric thickeners, and water. In a particular embodiment, the adhesive used herein may be SprayClean™ 1404, Fabond, or equivalent from Worthen Industries. In another embodiment, the adhesive may be selected to have a SBR base. This SBR based adhesive may further have other lattices such as those listed above, as well as a polychloroprene latex. In still another embodiment, the adhesive may be selected to have a natural rubber latex base. This natural rubber latex based adhesive may further have other lattices such as those listed above, as well as a polychloroprene latex.

Generally, the activator contemplated herein may be any acid or salt solution, or dispersion capable of activating the adhesive component, making it highly tacky and adherent. Examples of activators may include, but are not limited to: Acids such as: hydrochloric acid, phosphoric acid, sulfuric acid, nitric acid, boric acid, oxalic acid, acetic acid, citric acid, lactic acid, glycolic acid, propionic acid, glycine, alanine, valine, leucine, isoleucine, lycine; sulfate salts such as: zinc sulfate, aluminum sulfate, potassium sulfate, sodium sulfate, magnesium sulfate, calcium sulfate, ammonium sulfate; nitrate salts such as: zinc nitrate, potassium nitrate, sodium nitrate, magnesium nitrate, calcium nitrate and ammonium nitrate; ammonium salts such as: ammonium nitrate, ammonium sulfate, ammonium chloride; chloride salts such as: zinc chloride, potassium chloride, sodium chloride, magnesium chloride, calcium chloride, and the like. These acids and salts are generally solvated in water at varying concentrations, typically at 30% or less. More typically in the range of 2 to 15%. In another embodiment, the activator may be a dispersion of sodium silicofluoride in water, or other similar dispersion.

In one embodiment, the present invention may be entirely airless, in that both the adhesive and the activator are sprayed through an atomizing nozzle and without using air to atomize them. In one embodiment, a single mechanical trigger may have a forked shape to draw back two needles simultaneously, each needle fitting within a nozzle seat to control fluid flow through a nozzle. When the fluid (activator or adhesive) passes through the nozzle, it is atomized by the forces caused by passing through the nozzles. These atomizing forces can be caused by a shape of the nozzle, pressures caused by movement through the nozzles, and/or a combination of the two.

In further embodiments, the two component airless spray gun may be replaced with a mechanized or automated spraying machine. In this embodiment, the spray device may be automated, as opposed to control by a person using a hand spray gun. In this embodiment, sensors such as optical, location, thermal, and the like, may control the activation of the spray nozzle, activating the spraying onto the desired surface. Robotic assembly may also be involved in these embodiments. Overspray may be a particularly important phenomenon to avoid for mechanized embodiments because the expensive machinery will be fouled by the adhesive cloud, jamming the machinery and otherwise leading to its wear and malfunction. As with the above embodiment, the mechanized embodiment also utilizes a mechanical only pull with pressurized adhesive and activator to provide their atomization.

Nozzle orifice sizes for both the adhesive and activator may vary depending on embodiment, and it should be understood that any orifice sizes may be used without straying from the scope of the present invention. In a particular embodiment, the nozzle may have an inner orifice and outer spray tip. This nozzle may have an outer spray tip orifice size of approximately 0.127 mm to 1.35 mm. In a further embodiment, the outer spray tip orifice size may be approximately 0.66 mm. The inner orifice may have an orifice size of 0.127 mm to 3.81 mm. In a further embodiment, the inner orifice may have an orifice size of 0.635 mm to 1.53 mm.

The unique design of the present invention is configured to allow both spray chambers and nozzles to be positioned on the same spray gun. The nozzles may be angled towards each other to enable the activator to mix with the adhesive at a predetermined distance from the spray gun to avoid fogging. The activator spray nozzle is capable of limiting the volume of activator due the small orifice size and pressure. In the present embodiment, the activator nozzle may have an inner orifice and outer spray tip. This nozzle may have an outer spray tip orifice size of approximately 0.127 mm to 1.35 mm (0.005″ to 0.053″). In a further embodiment, the inner orifice may have an orifice size of 0.635 mm to 1.53 mm (0.025″ to 0.060″).

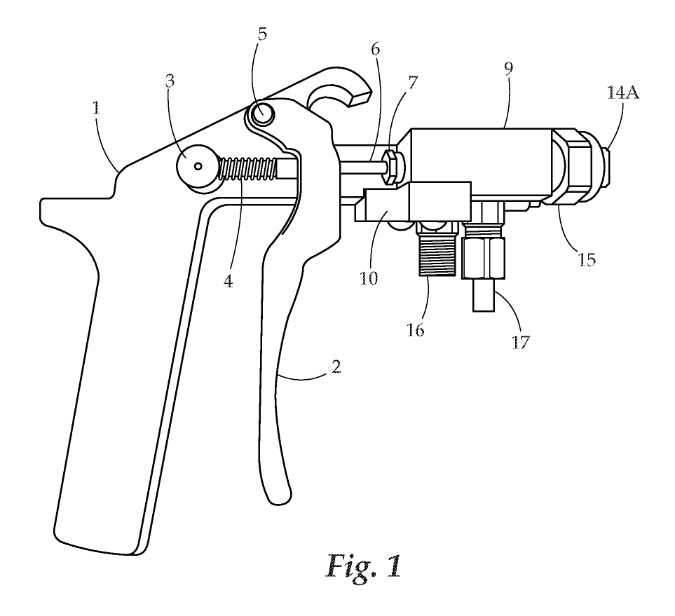

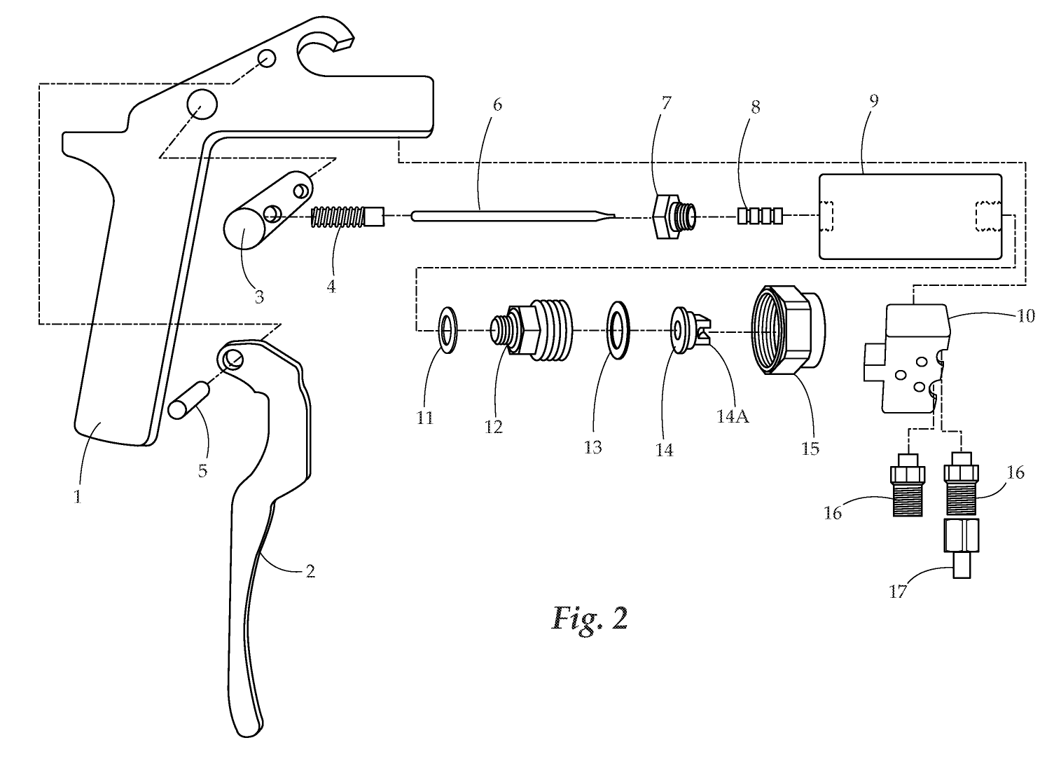

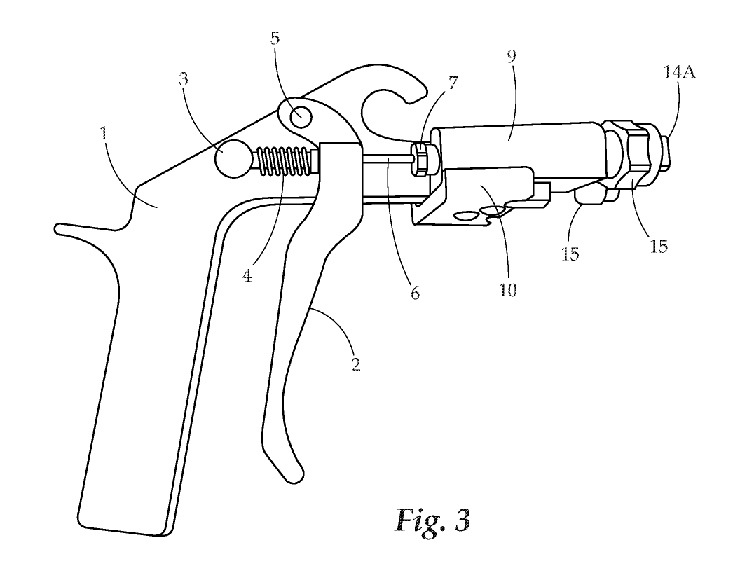

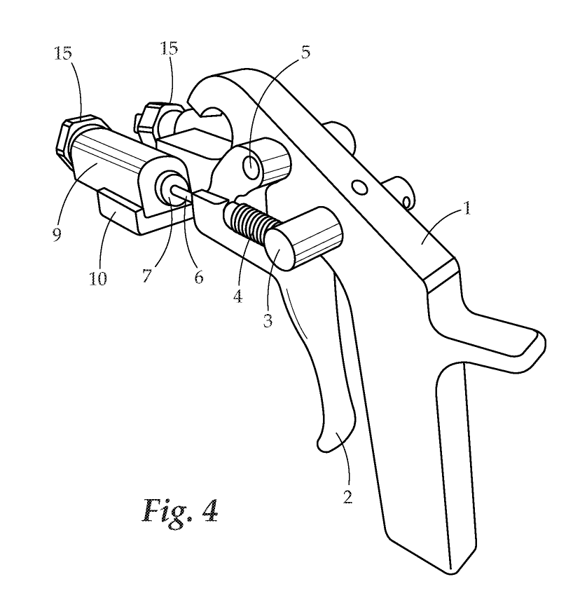

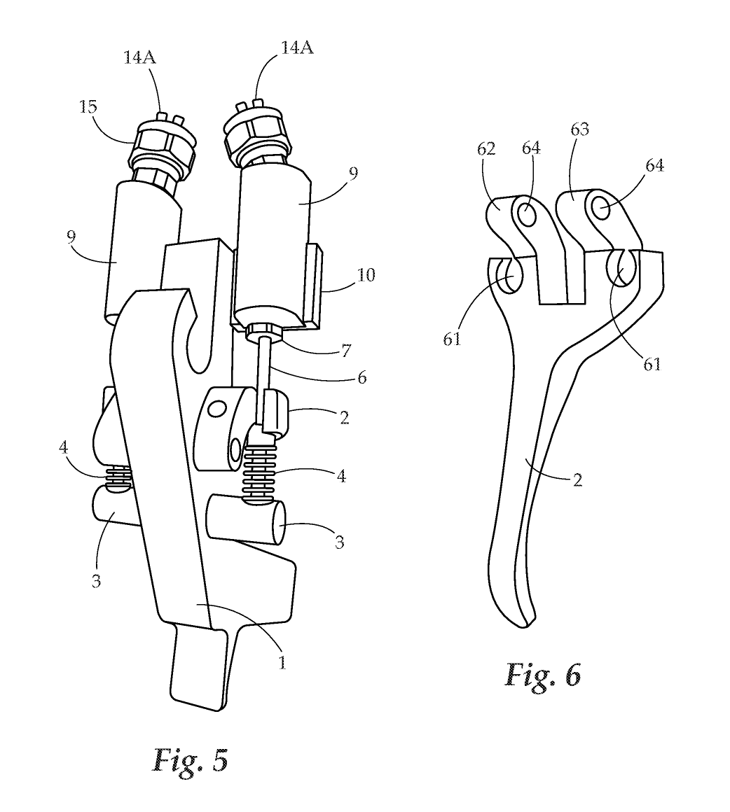

Turning now to FIGS. 1-6, various embodiments of the two-component spray gun system are shown. In the embodiments shown, the spray gun is fully airless. Such that only fluid pressure is used to achieve atomization through the nozzles, and such that the needles are activated only by motion of the trigger. However, other embodiments are possible without straying from the scope of this invention. The spray gun has a body 1 which provides a handle, as well as structure and support for the gun and components. Two fluid cylinder chambers 9 are mounted to a front of the body 1 on opposite sides of the body 1. One cylinder 9 for spraying adhesive, and one cylinder 9 for spraying activator. Cylinder support 10 provides stability and connection of the cylinders 9 to the body 1. Adhesive and activator nipples 16, 17 allow connection of an appropriate component of the system to the spray gun chambers by, for example, a hose connection. The adhesive and activator sources may be any vessels that may hold the adhesive or activator. Connection to the spray gun may be in any manner including direct connection, hose, piping, and the like. The sources may be pressurized, or may have an additional pressure source such as a pump, gravity, and the like.

On a front end of each cylinder 9, a nozzle is connected. The nozzle includes gaskets as O-rings 11, 13. Fluid nozzle 12 is shown in this embodiment to be threadedly connectable to cylinder 9. Downstream of the nozzle is the spray tip 14, 14A. The nozzle 12 and spray tip 14 provide the atomization of the activator/adhesive, as well as the pattern of spray. The spray tip is held in place to the nozzle 12 by tip holder nut 15.

Operation of the spray gun (spraying or preventing fluid flow) is controlled by the trigger 2 and needle assembly of each chamber. A single trigger 2 is used to control both needle assemblies which are on opposite sides of the body. As can be seen in FIG. 6, the single trigger 2 is configured to have a forked ‘Y’ shape, with the lower, single portion of the Y being where the trigger 2 is pulled by a user, and two upper side portions 62 and 63 being used to control movement of one of the two needle assemblies. As configured, the single trigger 2 may effectively draw the needle assemblies back equally when pulled, and therefore the Y shaped trigger 2 provides control of both activator and adhesive fluid spray chambers. In the embodiment shown, trigger 2 is connected to body 1 by trigger stud 5 passing through apertures 64 on both side portions 62, 63.

The needle assembly may be formed of multiple pieces. Needle 6 is configured to seat into nozzle 12 when in a resting position blocking flow there through, and when drawn away from the nozzle 12 by pulling of the trigger 2, fluid can flow through the nozzle to be atomized. A portion of the needle 6 passes through or is otherwise in communication with the trigger 2, to allow the trigger to control positon of the needle. Packing 8 and packing nut 7 fit into a rear of the chamber 9, and needle 6 is slideably passed through them. A needle spring 4 biases the needle 6 and trigger 2 in the closed position with the needle urged against a seat of the nozzle 12, blocking fluid flow. Needle support 3 is attached to body 1 and provides a support for a rear of the needle 6 and for the spring 4.

In a particular embodiment, a radius ball or cylinder and socket may be integrated into the needle assembly to allow the trigger to provide a straight line pull on its arced path when being drawn back and forth. This structure includes a ball (not shown in FIG. 6) movably seated in a socket 61 of the trigger on both side portions 62, 63. The ball can freely rotate within the socket 61. In one embodiment, an aperture is formed through the ball with the needle 6 passing through this aperture. In another embodiment, the needle 6 may terminate at the ball within the socket 61. During the arced movement of the trigger, the ball can rotate within the socket and shift upwardly or downwardly within the socket to keep the needle correctly oriented, minimizing stresses on the needle. For example, the socket 61 may have a height greater than a height of the ball, such that the ball can move up and down within the socket.

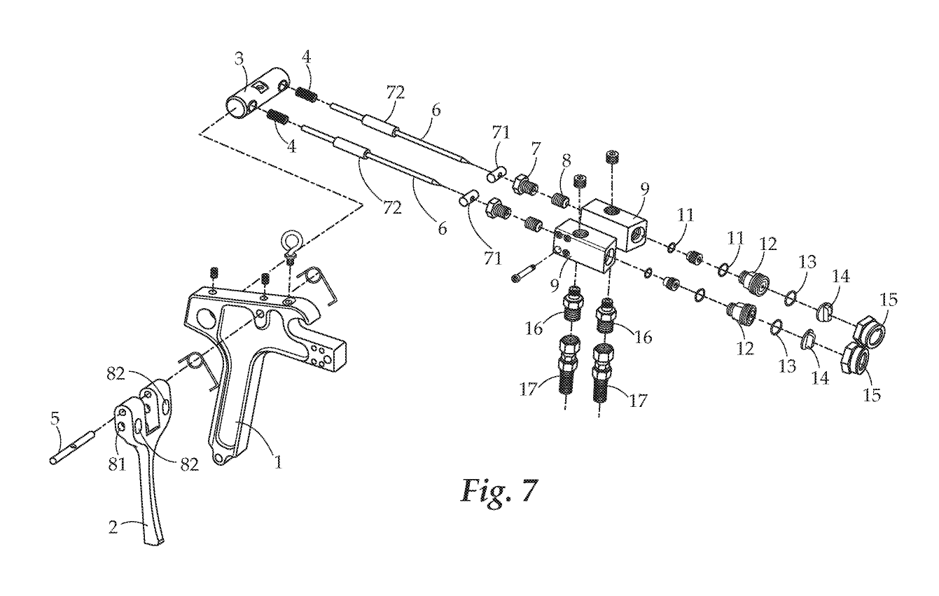

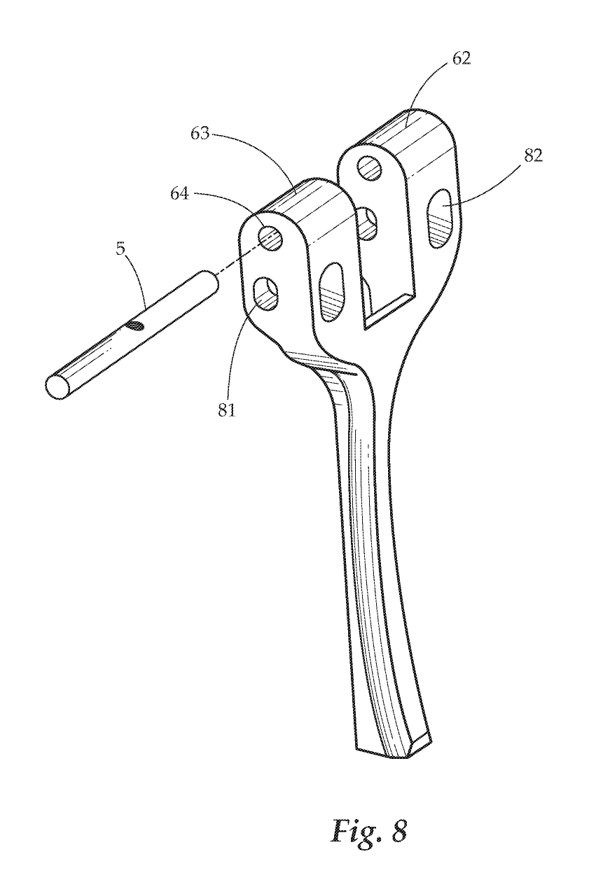

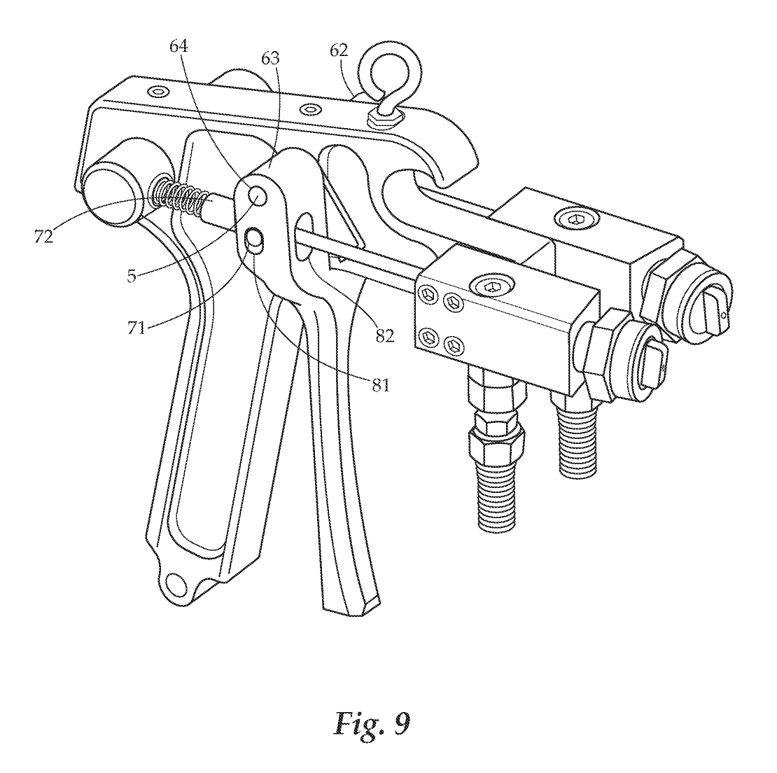

Turning to FIGS. 7-9, another embodiment of the present invention is provided. This embodiment utilizes a trigger arrangement that allows a cylinder to move somewhat within a slot of the trigger to eliminate stresses on the needles when being drawn by the trigger. In this embodiment, trigger 2 has two side portions 62, 63. In each side portion, a socket 81 for a cylinder 71 to seat is formed. The socket 81 has a cross section such that cylinder 71 can move freely upwardly and downwardly to some extent—here shown as an oval cross section—but other shapes may be used. As can be best seen in FIG. 9, the cylinder 71 has a smaller cross section than the socket 81. Each side portion 62 also has an aperture 82 that allows the needle to move upwardly and downwardly, and/or change angles relative to the trigger 2 without contacting the trigger 2. The structure shown with the movable cylinder 71 seated in the trigger socket 81 ensures that during the arced movement of the trigger, the cylinder 71 can rotate within the socket 81 and shift upwardly or downwardly within the socket 81 to keep the needle correctly oriented, minimizing stresses on the needle.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention and are inclusive, but not limited to, the following appended claims as set forth.

What is claimed is:

1. An airless spray gun comprising:
a body having a handle;
a trigger, the trigger attached to the body, the trigger having a first side portion on a first side of the body and a second side portion on a second opposite side of the body;
a first fluid chamber on the first side of the body having a spray nozzle and a fluid inlet;
a second fluid chamber on the second side of the body having a spray nozzle and a fluid inlet;
a first needle assembly connected to the trigger first side portion and to the first fluid chamber, the first needle assembly configured to prevent fluid flow through the spray nozzle when in a closed position, and configured to allow fluid flow through the spray nozzle when in an open position, a position of the first needle assembly controlled by a position of the trigger; and
a second needle assembly connected to the trigger second side portion and to the second fluid chamber, the second needle assembly configured to prevent fluid flow through the spray nozzle when in a closed position, and configured to allow fluid flow through the spray nozzle when in an open position, a position of the second needle assembly controlled by a position of the trigger.

2. The airless spray gun of claim 1 further comprising a spring attached to the body and the trigger, the spring configured to bias the trigger in a closed position to bring the first and second needle assemblies to the closed position.

3. The airless spray gun of claim 1 wherein the nozzle of the first fluid chamber and the nozzle of the second fluid chamber are angled toward each other.

4. The airless spray gun of claim 1 wherein the trigger first side portion and trigger second side portion each form a socket, a cylinder or ball movably seated in each socket having an aperture through which a portion of the needle assembly passes.

5. The airless spray gun of claim 1 wherein the first nozzle is configured to spray an adhesive, and wherein the second nozzle is configured to spray an adhesive activator.

6. The airless spray gun of claim 1 wherein the trigger is connected to the body by a stud passing through an aperture of the body and connecting to the trigger first side portion and trigger second side portion.

7. The airless spray gun of claim 1 wherein the first and second nozzles are removable from the fluid chamber.

8. The airless spray gun of claim 1 wherein the trigger is pivotally attached to the body.

9. The airless spray gun of claim 1 wherein the first needle assembly and second needle assembly each comprise a spring.

10. The airless spray gun of claim 1 wherein the first nozzle comprises a removable spray tip.

11. An airless two component adhesive spray gun assembly comprising:
a spray gun, the spray gun comprising:
a body having a handle;
a trigger, the trigger attached to the body, the trigger having a first side portion on a first side of the body and a second side portion on a second opposite side of the body;
a first fluid chamber on the first side of the body having a spray nozzle and a fluid inlet;
a second fluid chamber on the second side of the body having a spray nozzle and a fluid inlet;
a first needle assembly connected to the trigger first side portion and to the first fluid chamber, the first needle assembly configured to prevent fluid flow through the spray nozzle when in a closed position, and configured to allow fluid flow through the spray nozzle when in an open position, a position of the first needle assembly controlled by a position of the trigger;
a second needle assembly connected to the trigger second side portion and to the second fluid chamber, the second needle assembly configured to prevent fluid flow through the spray nozzle when in a closed position, and configured to allow fluid flow through the spray nozzle when in an open position, a position of the second needle assembly controlled by a position of the trigger;
an adhesive source, the adhesive source connected to the fluid inlet of the first fluid chamber; and
an adhesive activator source connected to the fluid inlet of the second fluid chamber.

12. The assembly of claim 11 further comprising a spring attached to the body and the trigger, the spring configured to bias the trigger in a closed position to bring the first and second needle assemblies to the closed position.

13. The assembly of claim 11 wherein the nozzle of the first fluid chamber and the nozzle of the second fluid chamber are angled toward each other.

14. The assembly of claim 11 wherein the trigger first side portion and trigger second side portion each form a socket, a cylinder or ball movably seated in each socket having an aperture through which a portion of the needle assembly passes.

15. The assembly of claim 11 wherein the first nozzle is configured to spray the adhesive, and wherein the second nozzle is configured to spray the adhesive activator.

16. The assembly of claim 11 wherein the trigger is connected to the body by a stud passing through an aperture of the body and connecting to the trigger first side portion and trigger second side portion.

17. The assembly of claim 11 wherein the first and second nozzles are removable from the fluid chamber.

18. The assembly of claim 11 wherein the trigger is pivotally attached to the body.

19. The assembly of claim 11 wherein the first needle assembly and second needle assembly each comprise a spring.

20. The assembly of claim 11 wherein the first nozzle comprises a removable spray tip.
